(19) United States
(12) Patent Application Publication
(10) Pub. No.: US 2018/0138555 A1
(43) Pub. Date: May 17, 2018

(54) SELF-SWITCHING DUAL VOLTAGE BATTERY

(71) Applicant: Gulfstream Aerospace Corporation, Savannah, GA (US)

(72) Inventor: Michael Knight, Savannah, GA (US)

(21) Appl. No.: 15/354,251

(22) Filed: Nov. 17, 2016

(51) Int. Cl. H01M 10/42; H01M 10/24; H01M 10/0525; H01M 10/34

(52) U.S. Cl. CPC H01M 10/4207; H01M 10/425; H01M 10/24; H01M 2010/4271; H01M 10/345; H01M 2220/20; H01M 10/0525

(57) ABSTRACT

A self-switching dual voltage battery system includes a plurality of battery cell groups connected in series to provide a first voltage between a negative terminal and a first positive terminal. A switch matrix couples a selected one of the plurality of battery cell groups to a second positive terminal to provide a second voltage. A controller coupled to each of the plurality of battery cell groups monitors a charge level associated with each of the plurality of battery cell groups. When the controller determines that the charge level associated with the selected battery cell group falls below a threshold, the controller causes the switch matrix to select another battery cell group from the plurality of battery cell groups to provide the second voltage.

### TECHNICAL FIELD

The present invention relates generally to a vehicle battery and more particularly to a self-switching, dual voltage battery suitable for use in an aircraft.

### BACKGROUND

Contemporary business aircraft have generally standardized on a 28 volt direct current (28 VDC) power supply (e.g., battery) to power the various navigation, flight control, and other systems used on board an aircraft. Historically, as aircraft power demands have increased, many aircraft manufacturers elected to generate higher voltage alternating current power supplies (e.g., 115 VAC) for routing power throughout the aircraft fuselage, and converting down to 28 VDC locally to power aircraft systems. Additionally, by generating a higher voltage for transmission throughout the aircraft fuselage, a lower current is required to provide a given power level as will be appreciated by those skilled in the art (i.e., Ohm's law). By reducing current requirements, a higher gauge (i.e., smaller diameter) wire can be used, which affords a substantial weight reduction given the miles of wire that are used in an aircraft.

Currently, in an effort to further reduce wire weight, some aircraft manufacturers have begun generating power at even higher voltages (e.g., 235 VAC or 270 VDC) that is converted by dedicated transformer rectifier units to 28 VDC and re-distributed to power aircraft systems. While down-converting of higher voltage power to 28 VDC is generally efficient, no power-converting system is 100% efficient and some power is lost as heat during the voltage conversion process. When the aircraft is parked without connection to ground power sources, it is dependent upon batteries to continue to provide time-limited power to some aircraft systems that remain powered when the aircraft is not in use (e.g., security system, cellular connections). Even a 1%-2% loss during the conversion from a high voltage direct current battery to nominal 28 VDC would drain the battery after a few days due to the heat lost during the conversion. Carrying a dedicated 28 VDC battery to power these systems without the need for conversion adds weight, cost, and additional wiring that is undesirable.

Accordingly, it is desirable to provide a power source (i.e., battery) that can provide a high-voltage direct current power source to reduce wire weight and also provides a 28 VDC power source without voltage conversion loss. It is further desirable that the 28 VDC power source have an extended capacity for use on aircraft over a long period of time. Furthermore, other desirable features and characteristics will become apparent from the subsequent detailed description and the appended claims, taken in conjunction with the accompanying drawings and the foregoing technical field and background.

### BRIEF SUMMARY

Various non-limiting embodiments of a self-switching dual voltage battery and a method of operating a self-switching dual voltage battery are disclosed herein.

In a first non-limiting embodiment, the self-switching dual voltage battery system includes, but is not limited to, a plurality of battery cell groups connected in series to provide a first voltage between a negative terminal and a first positive terminal. The self-switching dual voltage battery system also includes, but is not limited to, a switch matrix coupled to each of the plurality of battery cell groups and to a second positive terminal. The self-switching dual voltage battery system also includes, but is not limited to, a controller coupled to the switch matrix for controlling the switch matrix to couple a selected battery cell group of the plurality of battery cell groups to the second terminal to provide a second voltage. The controller is also coupled to each of the plurality of battery cell groups for monitoring a charge level associated with each of the plurality of battery cell groups. In this way, when the controller determines that the charge level associated with the selected battery cell group falls below a threshold, the controller causes the switch matrix to select another battery cell group from the plurality of battery cell groups to provide the second voltage.

In another non-limiting embodiment, a method of operating a self-switching dual voltage battery system includes, but is not limited to, providing a first voltage between a negative terminal and a first positive terminal from a plurality of battery cell groups connected in series. The method further includes, but is not limited to, monitoring, via a controller, a charge level associated with each of the plurality of battery cell groups. The method further includes, but is not limited to, controlling a switch matrix to select one of the plurality of battery cell groups to provide a selected battery cell group between the negative terminal and the second positive terminal. The method further includes, but is not limited to, determining when the charge level associated with the selected battery cell group falls below a threshold. The method further includes, but is not limited to, controlling the switch matrix to select another battery cell group from the plurality of battery cell groups to provide the second voltage when the charge level associated with the selected battery cell group falls below the threshold.

### BRIEF DESCRIPTION OF THE DRAWINGS

The present invention will hereinafter be described in conjunction with the following drawing figures, wherein like numerals denote like elements, and

FIG. 1 is an illustration of a conventional battery;

FIG. 2 is a block diagram illustrating a non-limiting embodiment of a self-switching dual voltage battery in accordance with the teachings of the present disclosure; and,

FIG. 3 is a flow chart illustrating a non-limiting embodiment of a method for operating a self-switching dual voltage battery.

### DETAILED DESCRIPTION

As used herein, the word “exemplary” means “serving as an example, instance, or illustration.” The following detailed description is merely exemplary in nature and is not intended to limit application and uses. Any embodiment described herein as “exemplary” is not necessarily to be construed as preferred or advantageous over other embodiments. All of the embodiments described in this Detailed Description are exemplary embodiments provided to enable persons skilled in the art to make or use the embodiment and not to limit the scope that is defined by the claims.

A self-switching dual voltage battery is disclosed herein. The self-switching dual voltage battery of the present disclosure provides a first (high-voltage) output by serially coupling a plurality of battery cells or groups of cells. A second (28 VDC) output is also provided by selectively coupling one of the plurality of battery cell groups to a second (28 VDC) terminal. While the self-switching, dual voltage battery of the present disclosure is described as affording an advantage in an aircraft application, it will be appreciated that the present disclosure may be advantageously employed in other applications, including but not limited to, batteries for ground based vehicles, watercraft and spacecraft without departing from the teachings of the present disclosure.

A greater understanding of the self-switching, dual voltage battery and of the method of operating a self-switching, dual voltage battery may be obtained through a review of the illustrations accompanying this application together with a review of the detailed description that follows.

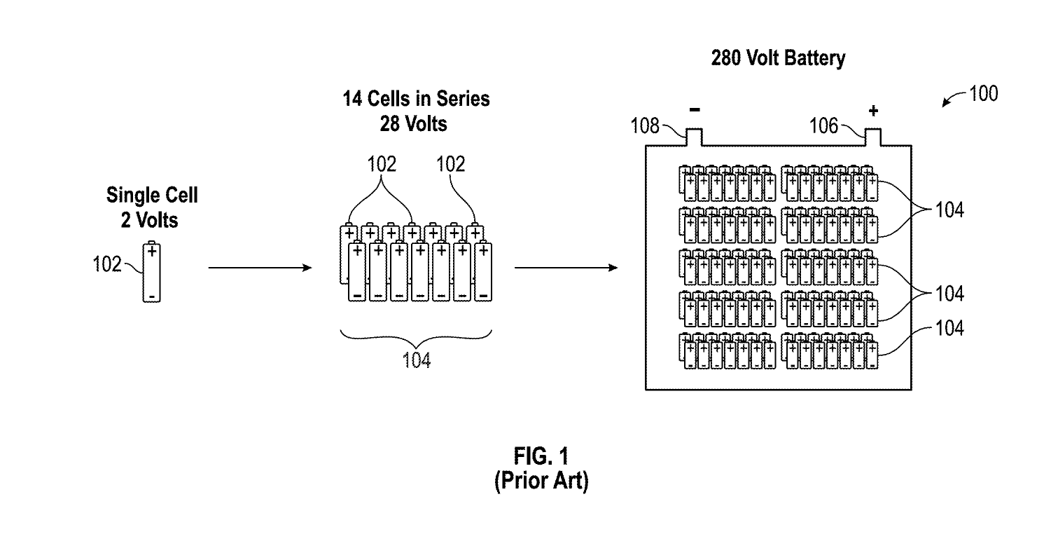

FIG. 1 is an illustration of a conventional battery 100. The battery 100 is comprised of a plurality of cells 102. Each individual battery cell 102 may, for example, provide 2 VDC. In other embodiments, each individual battery cell 102 may provide 1.5 VDC (alkaline), 1.2 VDC (NiMH or NiCAD) or 3.2 VDC (Li ion). A plurality of battery cells 102 are organized into a battery cell group 104 by coupling the individual battery cells in series. In the example illustrated in FIG. 1, fourteen battery cells 102 are serially connected to form battery cell group 104 providing 28 VDC. Similarly, a plurality of battery cell groups 14 are serially connected within battery 100 to provide 280 VDC between a positive terminal 106 and a negative terminal 108. As will be appreciated by those skilled in the art more or fewer battery cells can be used form a battery cell group and more or fewer battery cell groups could be used to form battery 100.

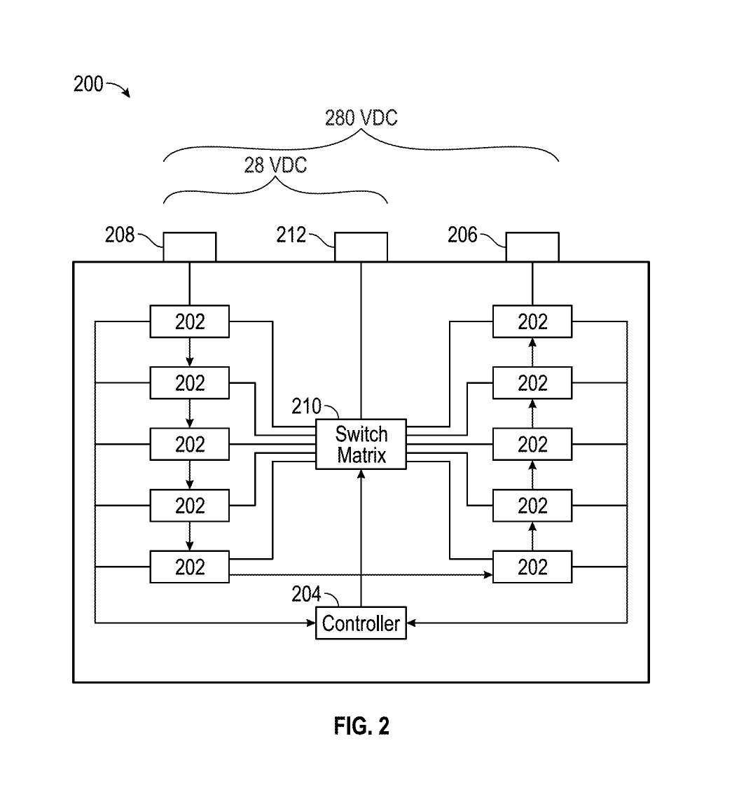

FIG. 2 is block diagram illustrating a non-limiting embodiment a self-switching dual voltage battery 200 in accordance with the present disclosure. The battery 200 is comprised of a plurality of battery cell groups 202 that are serially connected between a first positive terminal 206 and a negative terminal 208. As will be appreciated by those skilled in the art, the battery 200 provides a first voltage between the negative terminal 208 and the positive terminal 206 that is the sum of each of the individual voltages of the plurality of battery cell groups 202. In some embodiments, each battery cell group 202 is comprised of a plurality of battery cells, each battery cell providing 2 VDC such that each battery cell group 202 provides 28 VDC. In such an embodiment, the first voltage would be 280 VDC. In exemplary embodiments, each battery cell of a battery cell group 202 has a common battery chemistry and may be, in non-limiting embodiments, an alkaline battery cell, a metal-hydride battery cell, a lithium-ion battery cell or any other chemical-based electrical energy storage. In other embodiments, other electrical energy storage components (e.g., super-capacitors) could be employed in other implementations.

As illustrated in FIG. 2 each of the plurality of battery cell groups 202 is coupled to a controller 204 that monitors a current charge level associated with each of the plurality of battery cell groups 202. Additionally, each of the plurality of battery cell groups 202 is coupled to a switch matrix 210 that is also coupled to the controller 204. Under control of the controller 204, the switch matrix 206 selectively couples one of the plurality of battery cell groups 202 (a selected battery cell group) to a second positive terminal 212. In this way, the battery 200 provides a second (dual) voltage of 28 VDC between the negative terminal 208 and the second positive terminal 212. Since the second voltage is provided directly as an output of one of the plurality of battery cell groups 202, the second voltage (28 VDC) is provided without voltage conversion loss. In some embodiments, the switch matrix comprises a solid-state switch matrix that may include power transistors for switching the voltage-current combinations necessary to power an aircraft. Generally, exemplary embodiments of the present disclosure operate the switch matrix 210 in a parallel switching configuration. As used herein, a “parallel switching” operation means that the switch matrix 210 operates to disconnect a first battery cell group prior in parallel with connecting to another battery cell group. In this way, a circuit or system connected to the second positive terminal 212 does not temporarily experience an interruption or a doubling of supply voltage.

In operation, the controller 204 selects one of the plurality of battery cell groups 202 to provide a selected battery cell group that the switch matrix 210 couples to the second positive terminal 212. As the selected battery cell group powers the circuit or systems coupled to the second positive terminal 212, the controller 204 monitors the charge level associated with the selected battery cell group that will gradually be reduced under the load drawing power from the selected battery cell group. When the controller 204 determines that the charge level associated with the selected battery cell group drops below a threshold, the controller 204 causes the switch matrix to couple another of the plurality of battery cell groups to the second positive terminal 212. In some embodiments, the threshold used by the controller 204 to determine when to switch to another of the plurality of battery cell groups is fifty percent (50%) of the battery capacity of the selected battery cell group. As used herein, the “capacity” of a battery cell group means the amount of charge available in the battery cell group expressed in ampere-hours (or amp-hours). This process can continue throughout the plurality of battery cell groups providing a prolonged 28 VDC power supply to power select circuits of the aircraft.

As a non-limiting example, if each battery cell group 202 is rated to provide twenty amp-hours, then the battery 200 of FIG. 2 with ten battery cell groups 202 could provide 200 amp-hours of service while still having first voltage (280 VDC) available for aircraft operation. That is, when the aircraft is not powered-up, second voltage (28 VDC) can power selected lights and security systems for the aircraft while simultaneously having the first voltage (280 VDC) available to power-up the aircraft for operation. In the example presented having a threshold of 50% capacity for the controller to switch battery cell groups, the self-switching dual voltage battery 200 can provide 100 amp-hours of the second (28 VDC) voltage without the aircraft having to be powered-up for operation or the battery 200 having to be recharged. In practical terms, an aircraft incorporating the self-switching dual voltage battery 200 of the present disclosure could remain parked with select systems powered by the second voltage for over four consecutive days without requiring power from a ground station. Typically, standard operating procedures for contemporary business aircraft specify that batteries must be recharged after seventy-two hours of non-operation. Accordingly, the self-switching dual voltage battery 200 of the present disclosure readily meets this specification.

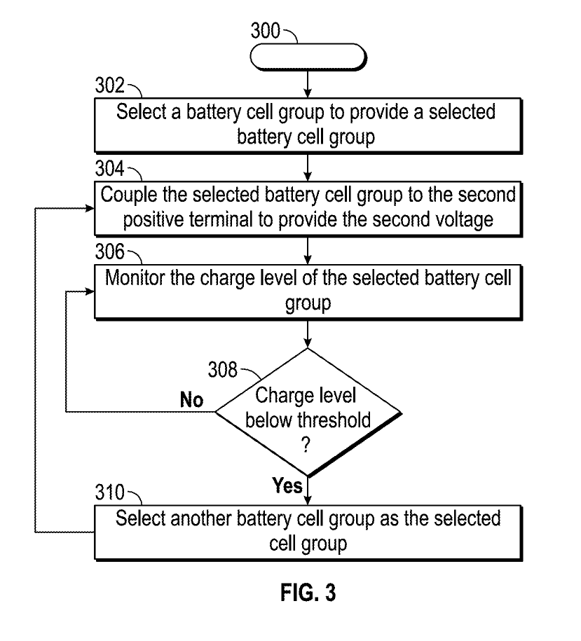

With continuing reference to FIG. 2, FIG. 3 illustrates a non-limiting embodiment of a method 300 for operating a self-switching dual voltage battery 200. The method 300 begins in block 302 where the controller (204 in FIG. 2) selects one of the plurality of battery cell groups (202) to be the selected battery cell group. In block 304, the controller causes the switch matrix (210 in FIG. 2) to couple the selected battery cell group to the second positive terminal to provide the second voltage between the negative terminal and the second positive terminal. While the selected battery cell group is providing the second voltage, the controller monitors the charge level of the selected battery cell group in block 306. Block 308 determines whether the charge level of the selected battery cell group has fallen below 50% of the capacity of the selected battery cell group. If not, the routine groups back to block 306 where the controller continues to monitor the charge level of the selected battery cell group. Conversely, if the determination of the controller (204) in block 308 is that the capacity of the selected battery cell group has fallen below 50% capacity, another battery cell group from the plurality of battery cell groups (202) is selected to be coupled to the second positive terminal to continue to provide the second voltage (block 304). The method 300 continues until the routine is stopped either for recharging of the self-switching dual voltage battery 200 or to power the aircraft for operation.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A self-switching dual voltage battery system, comprising:
a plurality of battery cell groups connected in series to provide a first voltage between a negative terminal and a first positive terminal;
a controller coupled to the switch matrix for controlling the switch matrix to select a selected battery cell group of the plurality of battery cell groups, the controller also coupled to each of the plurality of battery cell groups for monitoring a charge level associated with each of the plurality of battery cell groups; and
a switch matrix coupled each of the plurality of battery cell groups and being configured to couple the selected battery cell group to a second positive terminal and provide a second voltage between the negative terminal and the second positive terminal from the selected battery cell group,
wherein, when the controller determines that the charge level associated with the selected battery cell group falls below a threshold, the controller causes the switch matrix to select another battery cell group from the plurality of battery cell groups to provide the second voltage.

2. The system of claim 1, wherein each of the plurality of battery cell groups consist of a like number of battery cells connected in series.

3. The system of claim 2, wherein each battery cell provides two VDC.

4. The system of claim 3, wherein each of plurality of battery cell groups comprise fourteen battery cells connected in series to provide twenty-eight VDC.

5. The system of claim 2, wherein each of the battery cells have a common battery chemistry.

6. The system of claim 5, wherein the common battery chemistry is selected from one of the following group of battery chemistries: alkaline, metal hydride and lithium ion.

7. The system of claim 1, wherein each of the plurality of battery cell groups provide twenty-eight VDC as the second voltage when selected by the switch matrix to be coupled to the second positive terminal.

8. The system of claim 1, wherein the plurality of battery cell groups connected in series provide 280 VDC between the first positive terminal and the negative terminal.

9. The system of claim 1, wherein the threshold comprises fifty percent of a charge capacity of the selected battery cell group.

10. The system of claim 1, wherein the switch matrix comprises a plurality of solid state switches configured to operate in a parallel switching arrangement.

11. A self-switching dual voltage battery system, comprising:
a plurality of battery cell groups, each of the plurality of battery cell groups comprising a like number of battery cells having a common battery chemistry connected in series, the plurality of battery cell groups also being connected in series to provide a first voltage between a negative terminal and a first positive terminal, the first voltage being a sum of a second voltage provided by each of the plurality of battery cell groups;
a controller coupled to each of the plurality of battery cell groups for monitoring a charge level associated with each of the plurality of battery cell groups; and
a switch matrix coupled to each of the plurality of battery cell groups and the controller, the switch matrix being configured to couple a selected battery cell group of the plurality of battery cell groups to a second positive terminal to provide the second voltage from the selected battery cell group between the negative terminal and a second positive terminal,
wherein, when the controller determines that the charge level associated with the selected battery cell group falls below a threshold, the controller causes the switch matrix to select another battery cell group from the plurality of battery cell groups to provide the second voltage.

12. The system of claim 11, wherein each battery cell provides two VDC.

13. The system of claim 11, wherein each of the plurality of battery cell groups comprise fourteen battery cells to provide twenty-eight VDC.

14. The system of claim 11, wherein the common battery chemistry is selected from one of the following group of battery chemistries: alkaline, metal hydride and lithium ion.

15. The system of claim 11, wherein the plurality of battery cell groups connected in series provide 280 VDC between the first positive terminal and the negative terminal.

16. The system of claim 11, wherein the threshold comprises fifty percent of a charge capacity of the selected battery cell group.

17. The system of claim 11, wherein the switch matrix comprise a plurality of solid state switches configured to operate in a parallel switching arrangement.

18. A method of operating a self-switching dual voltage battery system comprising a plurality of battery cell groups connected in series to provide a first voltage between a negative terminal and a first positive terminal, each of the plurality of battery cell groups also being coupled to a switch matrix and a controller, the method comprising:
monitoring, via the controller, a charge level associated with each of the plurality of battery cell groups;
controlling, via the controller, the switch matrix to select one of the plurality of battery cell groups to provide a selected battery cell group coupled to a second positive terminal to provide a second voltage between the negative terminal and the second positive terminal;
determining when the charge level associated with the selected battery cell group falls below a threshold; and
controlling, via the controller, the switch matrix to select another battery cell group from the plurality of battery cell groups to provide the second voltage when the charge level associated with the selected battery cell group falls below the threshold.

19. The method of claim 18, wherein determining when the charge level associated with the selected battery cell group falls below a threshold comprise determining when the charge level associated with the selected battery cell group falls below fifty percent of a charge capacity of the selected battery cell group.

20. The method of claim 18, wherein controlling the switch matrix to select another battery cell group from the plurality of battery cell groups comprises causing the switch matrix to disconnect the selected battery cell group from the second positive terminal prior to coupling the another battery cell group to the second positive terminal to provide the second voltage.
